(19) United States
(12) Patent Application Publication
(10) Pub. No.: US 2014/0375746 A1
(43) Pub. Date: Dec. 25, 2014

(54) PLATFORM, DEVICE AND METHOD FOR ENABLING MICRO VIDEO COMMUNICATION

(71) Applicant: Wavedeck Media Limited, Tortola (VG)

(72) Inventors: Gideon SCHACHAT, Ra'anana (IL); David KATZ, Tel Aviv (IL)

(21) Appl. No.: 14/309,399

(22) Filed: Jun. 19, 2014

Related U.S. Application Data
(60) Provisional application No. 61/837,500, filed on Jun. 20, 2013.

(51) Int. Cl. H04N 7/14

(52) U.S. Cl. CPC H04N 7/141
USPC 348/14.01

(57) ABSTRACT

There is provided, in accordance with an embodiment of the present invention, an platform, system, device, protocol and method are provided to enable video enhanced Push To Talk (PTT) communications. According to some embodiments, a method is provided for enabling asynchronous two-way video communications, comprising: when a video message sender records a message, recording a micro video file; encoding the video file as a binary-to-text string; storing the string in a Real Time Data (RTD) storage on the sender device; synchronizing the local RTD data change with a RTD server; synchronizing the sender binary-to-text string with receiver RTD storage; decoding said video file from the binary-to-text string; and playing the micro video file on the sender device.

### CROSS REFERENCE TO RELATED APPLICATIONS

This application claims priority from U.S. Provisional Patent Application No. 61/837,500, filed 20 Jun. 2013, entitled “A PLATFORM AND METHOD FOR ENABLING ASYNCHRONOUS MICRO VIDEO COMMUNICATION”, which is incorporated in its entirety herein by reference.

### FIELD OF THE INVENTION

The present invention relates in general to platforms, devices and methods useful in enabling interpersonal communications, and in particular to usage of video data in communications between devices.

### BACKGROUND OF THE INVENTION

The rapid penetration of Smart phones into the market has also spurred the development of many advanced communication Applications, or Apps. What's App, for example, a proprietary, cross-platform instant messaging subscription service for smartphones that uses the internet for communication. Beyond text messaging, users can send each other images, video, and audio media messages as well as their location using integrated mapping features.

In a different space, people have been using have known Push to Talk communications for a long time, which may be described method of having conversations or talking on half-duplex communication lines, including two-way radio, using a momentary button to switch from voice reception mode to transmit mode. More recently, Push to Talk over Cellular (PoC) is an available service option for a cellular phone network that enables subscribers to use their phones as walkie-talkies with unlimited range.

However, It would be highly advantageous to have a system or method that could enable Push to Talk type functionality using Video files.

### SUMMARY OF THE INVENTION

There is provided, in accordance with an embodiment of the present invention, an apparatus, system, protocol, device and method are provided to enable, substantially in real time, enhanced Push To Talk (PTT) communications.

According to some embodiments, a method is provided for enabling asynchronous two-way video communications, comprising: when a video message sender records a message, recording a micro video file; encoding the video file as a binary-to-text encoding string; storing the string in a Real Time Data (RTD) storage on the sender device; synchronizing the local RTD data change with a RTD server; synchronizing the sender binary-to-text encoding string with receiver RTD storage; decoding said video file from the binary-to-text encoding string; and playing the micro video file on the sender device.

In some embodiments the binary-to-text encoding string is a Base64 encoded string.

In further embodiments, a user profile picture may be morphed into a profile video image for the duration of a micro video run; and a profile video image may be morphed back to a user profile picture following a micro video run.

According to some embodiments, an instant messenger protocol is provided for enabling near real time video data transfer, comprising: encoding a video file recorded by a sender as a base64 string on a sender's device; synchronizing the base64 string with a RTD server; synchronizing the base64 string between the RTD server and a receiver's device; decoding the video file from the base64 string; and playing the micro video file on the sender device, substantially in real time.

In further embodiments, the playing of the micro video file is used to enable Push To Talk (PTT) video communications.

In still further embodiments, the communications device is in communication with a data server, which includes a file with instructions to synchronize the string between a sender device and a receiver device, to facilitate substantially real time video data transfer between remote communication devices.

According to some embodiments, a communications device is provided for enabling asynchronous two-way video communications, the device including: a file with instructions to encode a recorded video file as a binary-to-text encoded string representing a micro video file; and a file with instructions to decode a recorded video file as a binary-to-text encoded string representing a micro video file; wherein the communications device is in communication with a data server, which includes a file with instructions to synchronize the string between a sender device and a receiver device, to facilitate substantially real time video data transfer between remote communication devices.

In further embodiments the binary to text encoded string is a Base64 encoded scheme.

In other embodiments the files with instructions are included within a downloadable Application, such that users of said Application can communicate video files to each other using said Application.

In other embodiments the communications device further comprises a real time database adapted to maintain synchronized Application data.

In additional embodiments the communications device is in communication with a Push to Video (PTV) platform server.

In yet further embodiments the communications device further includes a real time data module configured to maintain synchronized Application data for connected user devices.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic system diagram depicting components of an asynchronous video communication system, according to some embodiments;

FIGS. 2A-2B are screen shots of examples of user interfaces showing a typical implementation of a Push To Video (PTV) messenger, according to some embodiments;

FIGS. 3A-3B are flow diagrams indicating examples of processes by which asynchronous video communications may be implemented, according to some embodiments; and

FIG. 4 is a flow diagram indicating example of a further process by which asynchronous video communications may be implemented, according to some embodiments.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “micro video” as used herein refers to a small format video that is of limited quality and/or resolution, but is rather optimized to be easy and quick to communicate with, for example, to transmit wirelessly or otherwise for effective video mobile communications, preferably from person to person.

Embodiments of the present invention enable asynchronous Micro video transfer between devices, thereby enable enhanced user engagement and interactivity when communication, while maintaining fast data transfer. In some embodiments, micro video data is configured to consume minimal bandwidth, possess only a portion of a device screen, provide a real time fees of engagement, high speed communication, optionally providing a 2 way radio experience (ie. Walkie talki format). In some embodiments Push To Talk (PTT) messaging enhanced with video data is provided, to allow asynchronous video communications at the push/release of a button. For example, In some examples of user experience, the micro video may morph from and/or into a profile picture or other static picture.

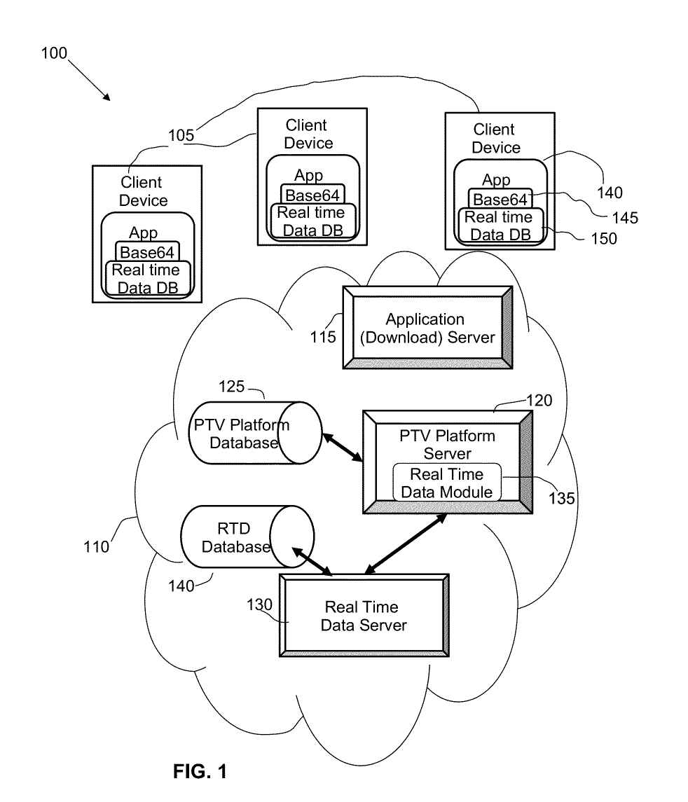

Reference is now made to FIG. 1, which is a schematic system diagram depicting a system 100 for facilitating the executing of a Push To Video (PTV) communication protocol, according to some embodiments. The system 100 includes multiple client devices 105 in communication with communications cloud 110. Communications cloud includes an Application Server 115, a PTV Platform Server 120, a PTV database 125, and a Real Time Data (RTD) Server 130.

Client Devices 105, which in general are communication and computing devices with video and audio capabilities, include a PTV application or program 140, to provide a user interface, data processing and data storage capabilities. PTV Application 140, in general downloadable from Application server 115 and executable on device 105, includes a data encoding/decoding module 145, for example Base 64 or other suitable technologies that represent binary data in text format such as an ASCII string format. Base64, for example, is an encoding scheme that is commonly used when there is a need to encode binary data that needs to be stored and transferred over media that are designed to deal with textual data. In some embodiments of the present invention, the fast transfer of micro video data (described below) should preferably be in textual format, therefore working with Base 64 or the equivalent may be a critical component, at the Application level. The Base64 module, in general, may process the video or graphic data captured on the end user device, and translate the data from Binary to ASCI format, in order to provide the video or graphic data in text format, which is fast and light to enable substantially real time data transfer.

PTV Application 140 includes a real time data storage (RTDS) module 150, for example a Firebase module, to store the Base64 data locally, for synching with the RTD Server 130. The RTD module 150 and RTD Server 130, for example a Firebase application module and Firebase cloud server, are to be used to provide real time data service from the communications cloud 110, to allow fast syncing of data or databases between different clients, like a web browsers or mobile devices, with the guiding principle being that any data that is written (locally) by one client gets synced to all other clients in near real time. In one embodiment, Firebase technology may be used, which is commonly used for chat applications or other applications which require fast textual data transfers. In some embodiments, a RTD storage module 150, for example a Firebase DB Module, may including a memory having stored thereon local Base64 data, to enable data synchronization with RTD Server 130, such as a Firebase server. In some embodiments the RTD server 130 is in communication with a RTD Database 140. The RTD server 130 is adapted to ensure that user data is synchronized with all connected devices, to enable a connected recipient device and sending device to be updated with video messages substantially in real time.

In some embodiments, a real time data notification module, such as PubNub or equivalent module may be used (not shown in the figure). PubNub is a real time data service that allows for fast sending of short textual messages between different clients, like web browsers or mobile devices. In some embodiments, PubNub may be used to implement activity indications, for example, to request that the user open their application, indicate who is talking, listening, awaiting a communication etc. Of course, other suitable message indicator tools may be used. In other embodiments, Video message Metadata may be used by the RTD storage to enable activity indications, instructional alerts etc.

Application Server 115 is in general a third party platform to deliver or download programs or Applications to remote users, for example, connected to the iTunes or Android Apps stores, or others. Application Server 115 may also serve to provide functionality to client applications, for example, to manage push notifications etc.

PTV Platform Server 120 in general may include code, script, protocols and logic to provide PTV implementation to the system. For example, PTV server 120 may include at least a file with instructions to execute commands to enable execution of a PTV communications protocol, described herein. PTV Platform Server 120 includes a RTD module 135, which includes scripts or code to handle and process communications sent to and/or received from RTD Server 130. In some embodiments PTV Server 120 may include a Notifications Backend (not shown in Fig), for example, for handling metafile data and generating metafile related notifications and alerts. PTV Platform Server 120 in general provides user customization functionality, including for example, managing user profiles, user groups, updating user contacts, applying user preferences, providing updates etc.

PTV database 125 is in coupled communication with PTV Platform Server 120, and is used to store and provide platform data, for example, user related data, connection data, and application related data. Database 125 in general may include a memory having stored thereon primarily non-message PTV content, but PTV database may store message content as well.

Real Time Data (RTD) Server 130 is used to receive, handle and transfer data from and to multiple clients and/or servers in near real time. In some embodiments, RTD server 130 is used to receive, handle and push text data, such as ASCI data provided by Base64 module 145, to enable synchronization of encoded video data to system users.

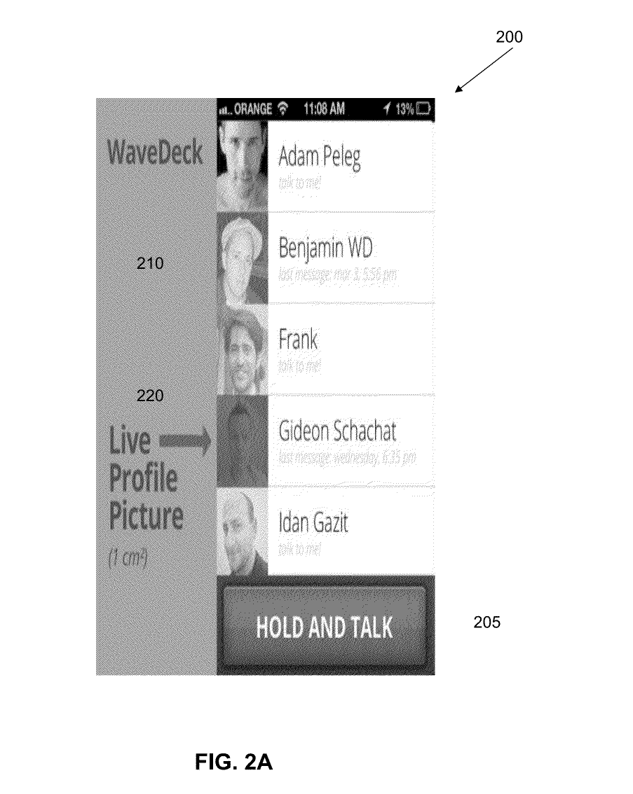

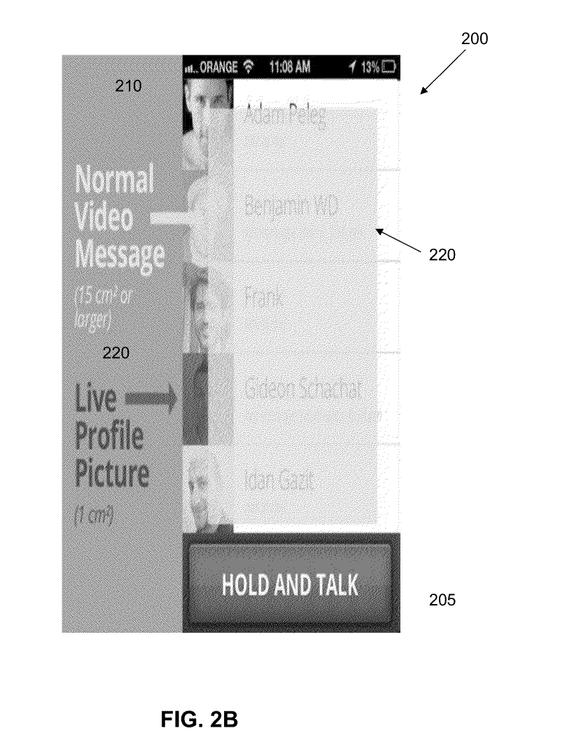

Reference is now made to FIGS. 2A-2B, which are examples of screen shots showing aspects of a user interface for executing 2 way video messaging, according to some embodiments. As can be seen in FIG. 2A, the Graphical User Interface (GUI) 200 includes a list of connections with profile pictures 210, and a message recording button 205, in general for allowing push or hold message recording, which is sent immediately upon releasing of the button. for recording a message. In some embodiments, such a recording may be in audio or video plus audio. In some embodiments the profile pictures may be live profile pictures (220), which may, for example, change from a still image to a micro video upon receipt of a message by that contact. In general the live profile picture will convert back to the standard still picture profile 210 when the message has been run.

In further embodiments, a user can view historical messages by clicking or touching a stills profile picture, which may optionally open up further options such as contact details, connection history, preferences etc.

In one example, for the sake of comparison, a Live Profile Picture 220 may cover around 1 cm² of screen area on an iPhone. A “normal” full screen or near full video message 230 covers between 16 cm² and 40 cm² of screen area. That makes Live Profile Pictures 15-40 times smaller than normal video. Such Live Profile Pictures are not designed for full video communication, such as video conferencing, as they are too small for that, as can be seen in the screenshots. Live Profile Pictures 220 are designed to provide some of the “liveness” of video, while letting the product stay focused on audio and quick push to talk (PTT) or Push To Video (PTV) messages.

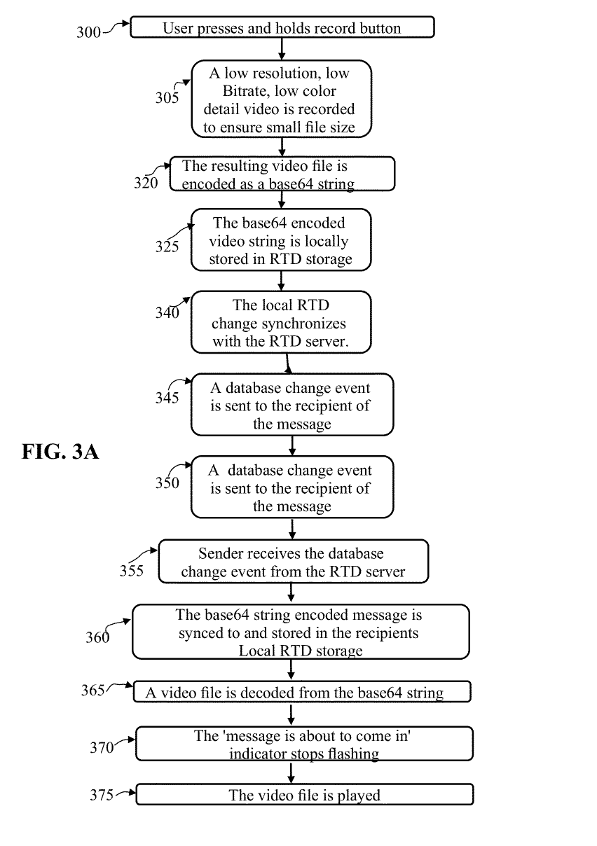

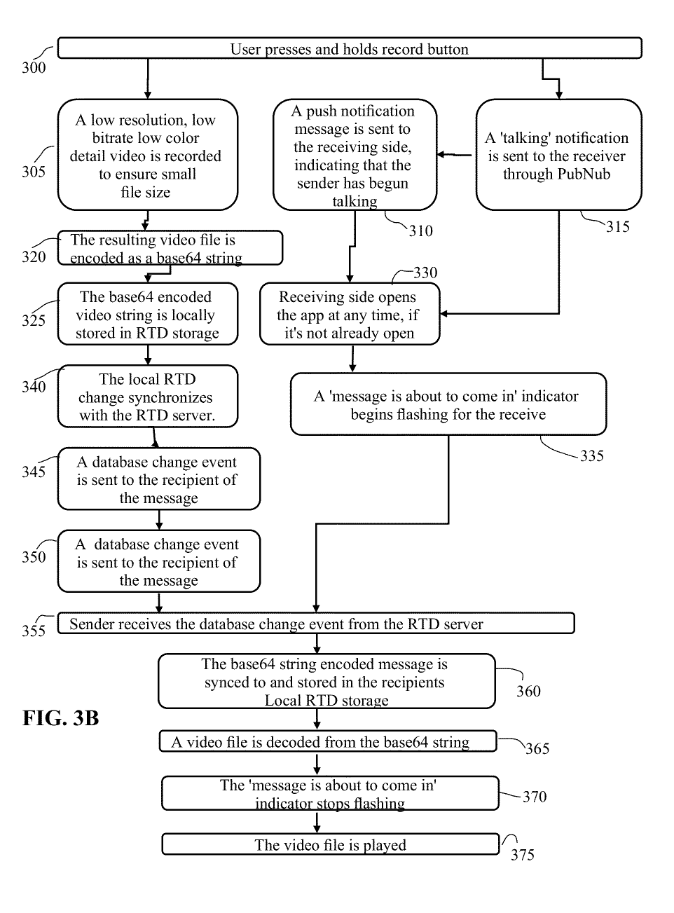

Reference is now made to FIG. 3A, which is a flow diagram showing a basic flow of steps in enabling the process or protocol by which Push To Video (PTV) communication and/or video messaging is managed, according to some embodiments. As can be seen in the figure, at step 300, user presses and holds a record button. At step 305 low resolution, low bitrate and low color detail video is recorded to enable preparation of a small or micro size video for substantially instantaneous transmission. At step 310 a push notification message is sent to the receiving side, indicating that the sender has begun recording a message. At step 315, in some embodiments, a ‘talking’ notification may be sent to the receiver through a notification service such as PubNub, which is an example of a fast messaging platform that uses open sockets. At step 320 the resulting video file is encoded as a base64 string. At step 325 the base64 encoded video string is locally stored in a RTD storage module, such as a FireBase database. Firebase, for example, is a fast, real time data syncing platform that may enable multiple clients to write data to local FireBase databases, and the FireBase server keeps them in sync, fast. At step 330, in some embodiments, the receiving side opens the app at any time, if it's not already open. At step 335 an alert, for example a ‘message is about to come in’ indicator, begins flashing or otherwise alerting the receiver. At step 340 the RTD storage module change synchronizes with the RTD server. At step 345 a database change event is sent to the recipient of the message. At step 350 a database change event is sent to the recipient of the message. At step 355 the sender receives the database change event from the RTD server. At step 360 the base64 string encoded message is synced to and stored in the recipients local RTD storage. At step 365 a video file is decoded from the base64 string. At step 370, in some embodiments, the alert (eg. ‘message is about to come in’ indicator) stops flashing or otherwise alerting. At step 375 the video file is played, completing the messaging process.

Reference is now made to FIG. 3B, which is a flow diagram indicating the process or protocol by which Push To Video (PTV) communication and/or video messaging is managed, according to further embodiments. As can be seen in the figure, at step 300, user presses and holds a record button. At step 305 low resolution, low bitrate and low color detail video is recorded to enable preparation of a small or micro size video for substantially instantaneous transmission. At step 320 the resulting video file is encoded as a base64 string. At step 325 the base64 encoded video string is locally stored in a RTD storage module, such as a FireBase database. Firebase, for example, is a fast, real time data syncing platform that may enable multiple clients to write data to local FireBase databases, and the FireBase server keeps them in sync, fast. At step 340 the RTD storage module change synchronizes with the RTD server. At step 345 a database change event is sent to the recipient of the message. At step 350 a database change event is sent to the recipient of the message. At step 355 the sender receives the database change event from the RTD server. At step 360 the base64 string encoded message is synced to and stored in the recipients local RTD storage. At step 365 a video file is decoded from the base64 string. At step 370, in some embodiments, the alert (eg. ‘message is about to come in’ indicator) stops flashing or otherwise alerting. At step 375 the video file is played, completing the messaging process.

In accordance with some embodiments, the video data sent from the RTD source may include video metadata and video content data. In accordance, the video metadata and video content data may be sent in two phases to the RTD server. In some cases, these distinct data groups may be used for providing enhanced functionality. For example, the video metadata may be used to trigger user alerts, commands, instructions etc. Accordingly, in some embodiments, no Pubnub or similar module is required in order to enable push notifications and activity notifications etc., rather the video metadata is used to enable these functions.

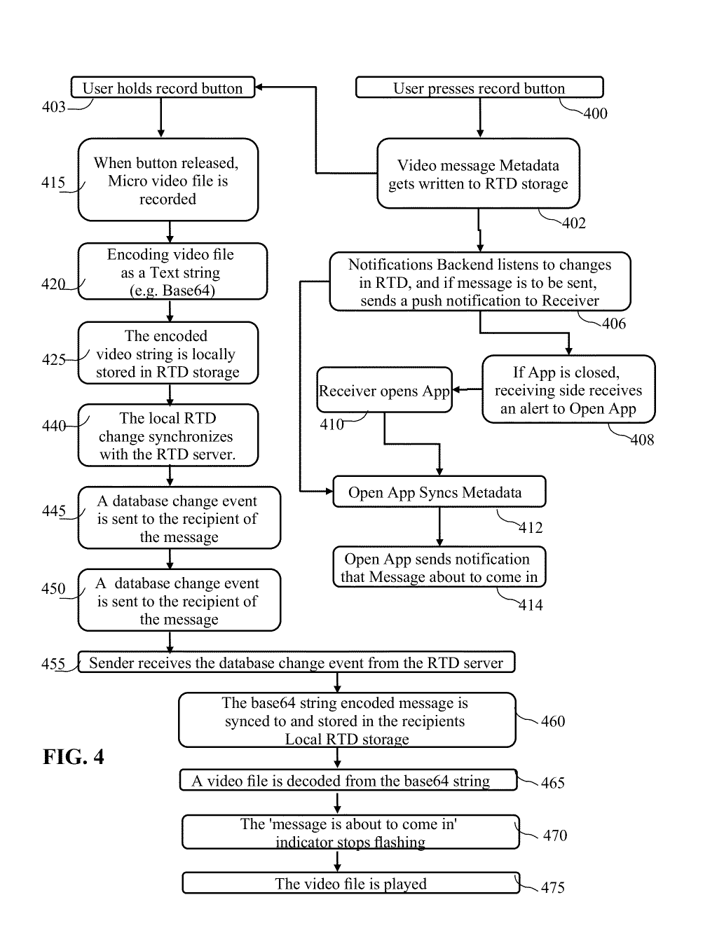

Reference is now made to FIG. 4, which is a flow diagram indicating the process or protocol by which Push To Video (PTV) communication in managed, according to further embodiments. As can be seen in the figure, at step 400, user presses a record button. At step 402 the video message metadata gets written to the RTD storage. At step 406 the Notifications Backend (generally in the cloud, working in communication with the RTD module 135) listens to changes in RTD, and if a message is identified as to be sent, the Notifications Backend sends a push notification to the Receiver side. At step 408, if the receiver side's PTV or micro video messaging related App is closed, the receiver side receives an alert or instruction to open the App. At step 410, the receiver opens the App. Once the App is open, at step 412, the metadata is synchronized. At step 414 the App may send a notification that a message is about to come in.

Returning to the video message data, at step 403 the user continues to record a video message by holding down or otherwise continuing the recording process. At step 415 when the recording is ceased, a micro video file is recorded, and the process continues with step 420. At step 420, the micro video file (ie. a low resolution, low bitrate and/or low color detail video message data, enabled to generate a small or micro size video for substantially instantaneous transmission) is encoded as a text string, for example, a base64 string. At step 425 the base64 encoded video string is locally stored in a RTD storage module, such as a FireBase database. At step 440 the RTD storage module change synchronizes with the RTD server. At step 445 a database change event is sent to the recipient of the message. At step 450 a database change event is sent to the recipient of the message. At step 455 the sender receives the database change event from the RTD server. At step 460 the base64 string encoded message is synced to and stored in the recipients local RTD storage. At step 465 a video file is decoded from the base64 string. At step 470, in some embodiments, the alert (eg. ‘message is about to come in’ indicator) stops flashing or otherwise alerting. At step 475 the video file is played, completing the messaging process.

According to certain embodiments, the asynchronous micro video communication protocol, as described above, may enable playback on demand, video history viewing, screen setting preferences determination etc.

According to certain embodiments, the asynchronous micro video communication protocol described herein may enable groups to be setup and managed, for example, to enable broadcast of micro videos to all group members.

According to certain embodiments, the asynchronous micro video communication protocol described herein may enable sending of files prior to the end of a file recording. For example, the system, process or protocol may determine that a video recording is transmitted automatically after x seconds of recording, thereby minimizing the gap which may associated with long recordings to be send and received. Of course, the streaming data transfer described above may be coupled with non-streaming data transfer.

According to certain embodiments, the asynchronous micro video communication protocol or format described herein may generate a near optimal file size and resolution adapted for enabling effective mobile communications, or other person to person communications, and especially video messaging communications. Of course, multiple size, quality, type formats may be used. Typically, the selected video format to be used is to be generated with a sufficiently low resolution to allow non-streaming usage to remote devices, such that push to talk functionality can be executed, wherein only a partial or small part of the user's screen is required. In some examples, a typical pixel size for a micro video may be 76×76 pixels, however other formats and pixel numbers may also me used.

According to certain embodiments, the asynchronous micro video communication protocol described herein may enable typical profile pictures to be modified or morphed from a stills image to a video clip, and subsequently return to the stills photo or image following running of a video message. The usage of a profile picture or image to display the user's video message is herein referred to as a live profile picture.

According to certain embodiments, the asynchronous micro video communication protocol described herein may enable selective profile background provision, for example, to allow a user to display their profile from a selected background. In still further embodiments profile pictures may be provided in alternative formats, resolutions etc., and optionally with graphic or multimedia effects.

According to certain embodiments, the asynchronous micro video communication protocol described herein may enable sending of advertisements or promotional materials in micro video.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A method for enabling asynchronous two-way video communications, comprising:
when a video message sender records a message, recording a micro video file;
encoding said video file as a binary-to-text encoded string;
storing said string in a Real Time Data (RTD) storage on the sender device;
synchronizing the local RTD data change with a RTD server;
synchronizing said sender binary-to-text encoded string with receiver RTD storage;
decoding said video file from said binary-to-text encoded string; and
playing said micro video file on the sender device.

2. The method of claim 1, where said binary-to-text encoded string is a Base64 string.

3. The method of claim 1, further comprising:
morphing of a user profile picture into a profile video image for the duration of a micro video run; and
morphing said profile video image back to a user profile picture following a micro video run.

4. An instant messenger protocol for enabling near real time video data transfer between communication devices, comprising:
encoding a video file recorded by a sender as a base64 string on a sender's device;
synchronizing said base64 string with a cloud based server;
synchronizing said base64 string between said cloud based server and a receiver's device;
decoding said video file from said base64 string; and
playing said micro video file on the sender device, substantially in real time.

5. The protocol of claim 3, wherein said playing of said micro video file is used to enable Push To Talk (PTT) video communications.

6. The protocol of claim 5, wherein the protocol can be applied on existing communication Applications to provide PTT video communications within said existing communication Application.

7. A communications device for enabling asynchronous two-way video communications, comprising:
a file with instructions to encode a recorded video file as a binary-to-text encoded string representing a micro video file; and
a file with instructions to decode a recorded video file as a binary-to-text encoded string representing a micro video file;
wherein said communications device is in communication with a data server, which includes a file with instructions to synchronize said string between a sender device and a receiver device, to facilitate substantially real time video data transfer between remote communication devices.

8. The communications device of claim 7, wherein said binary to text encoded string is a Base64 encoded scheme.

9. The communications device of claim 7, wherein said files with instructions are included within a downloadable Application, such that users of said Application can communicate video files to each other using said Application.

10. The communications device of claim 9, further comprising a real time database adapted to maintain synchronized Application data.

11. The communications device of claim 7, wherein said communications device is in communication with a Push to Video (PTV) platform server.

12. The communications device of claim 11, which further includes a real time data module configured to maintain synchronized Application data for connected user devices.
